(19) United States
(12) Patent Application Publication
(10) Pub. No.: US 2026/0123651 A1
(43) Pub. Date: May 7, 2026

(54) SMALL DOG FOOD COMPOSITION

(71) Applicant: MARS, INCORPORATED, McLean, VA (US)

(72) Inventors: Isabelle LESPONNE, Aimargues (FR); Benedicte GARZINO, Aimargues (FR); Lara FOSSATI, Aimargues (FR); Laura FAUVIAU, Aimargues (FR); Luis MOLINA, Aimargues (FR); Maxime SAUBLET, Aimargues (FR)

(73) Assignee: MARS, INCORPORATED, McLean, VA (US)

(21) Appl. No.: 19/117,343

(22) PCT Filed: Oct. 6, 2023
(86) PCT No.: PCT/US2023/034681

§ 371 Date: Mar. 31, 2025

(30) Foreign Application Priority Data
Oct. 7, 2022 (EP) 22200232.1

(51) Int. Cl. A23K 20/147; A23K 10/26; A23K 20/158; A23K 20/163; A23K 20/174; A23K 20/179; A23K 20/20; A23K 20/28; A23K 40/25; A23K 40/30; A23K 50/42

(52) U.S. Cl. CPC A23K 20/147; A23K 10/26; A23K 20/158; A23K 20/163; A23K 20/174; A23K 20/179; A23K 20/28; A23K 20/30; A23K 40/25; A23K 40/30; A23K 50/42

(57) ABSTRACT

The present disclosure provides an animal food composition comprising hydrolyzed proteins, fructooligosaccharides (FOS), maize starch, omega-3 fatty acids, omega-6 fatty acids, and 0.26 g/Mcal or less of zeolite by weight relative to the total dry matter weight of the composition, and its use for preventing and/or treating cutaneous adverse food reaction in small dogs.

### CROSS REFERENCE TO RELATED APPLICATIONS

This application claims priority to European Patent Application No. 22200232.1, filed on Oct. 7, 2022, which is incorporated herein by reference in its entirety.

### FIELD OF THE DISCLOSURE

The present disclosure relates to the field of animal food compositions for preventing and/or treating cutaneous adverse food reaction, such as allergic inflammatory skin diseases, while also catering to the specific needs and limitations of small dogs.

### BACKGROUND OF THE DISCLOSURE

Cutaneous adverse food reaction (cAFR) is a non-seasonal dermatitis induced by ingestion of allergens and accounts for nearly one in five pruritic dogs. Currently, diagnosis relies on performing an elimination diet trial followed by a re-challenge. A diet formulated with extensively hydrolyzed protein (consisting of free amino-acids and oligopeptides) and produced with stringent quality control measures has been proven efficacious in the diagnosis and management of cAFR.

However, while very efficient in the nutritional management of cAFR, these diets cannot be adapted to all animal populations and as such can present drawbacks or side effects.

Dermatological ailments remain a major issue in small animal practice with an estimated 15-30% of the world's dog population affected (Scott et al., Muller & Kirk's Small Animal Dermatology VI. Philadelphia, WB Saunders. 2001, pp: 543-666). Amongst the pruritic cases, nearly 20% of the dogs (Olivry T. and Mueller, R. S., Critically appraised topic on adverse food reactions of companion animals (3): prevalence of cutaneous adverse food reactions in dogs and cats. BMC Vet Res 13, 51 (2016)) have true immune-mediated reactions to antigens present in food and express cutaneous and/or gastrointestinal signs (Mueller R. S. and Olivry T., Critically appraised topic on adverse food reactions of companion animals (6): prevalence of noncutaneous manifestations of adverse food reactions in dogs and cats. BMC Vet Res 14, 341 (2018); and Olivry T, and Mueller, R. S., Critically appraised topic on adverse food reactions of companion animals (7): signalment and cutaneous manifestations of dogs and cats with adverse food reactions. BMC Vet Res 15, 140 (2019)). The recommended diagnostic approach involves an elimination diet trial followed by a challenge with the previous diet (Mueller R. S and Olivry T., Critically appraised topic on adverse food reactions of companion animals (4): can we diagnose adverse food reactions in dogs and cats with in vivo or in vitro tests? BMC Vet Res 13, 275 (2017)). However, it is essential to rule out secondary infections and ectoparasites as well endocrine disorders before pursuing a dietary trial (Olivry T. and Mueller R. S., Critically appraised topic on adverse food reactions of companion animals (9): time to flare of cutaneous signs after a dietary challenge in dogs and cats with food allergies. BMC Vet Res 16, 158 (2020)).

It was shown in the past that a diet formulated with an extensively hydrolyzed protein source along with maize starch and produced under rigorous quality control measures is a valuable solution for the diagnosis and management of food allergies in dogs (Lesponne et al., DNA and Protein Analyses to Confirm the Absence of Cross-Contamination and Support the Clinical Reliability of Extensively Hydrolysed Diets for Adverse Food Reaction-Pets. Vet. Sci. 2018; Cadiergues et al., Diagnostic value of home-cooked and an extensively hydrolysed diet (Anallergenic™, Royal Canin, France) in the diagnosis of canine adverse food reaction: a randomized prospective multicenter study in 72 dogs. Vet. Dermatol. 2016; 27 (Suppl.1), 6-121 and Bizikova P. and Olivry T., A Randomized, Double-blinded Crossover Trial Testing the Benefit of Two Hydrolysed Poultry-based Commercial Diets for Dogs with Spontaneous Pruritic Chicken Allergy. Vet. Dermatol. 2016; 27 (4): 289).

However, while efficient in treating adverse food reaction, these diets are not specifically adapted to the optimal nutritional management of small dogs, and as such, do not consider all the issues that arise with this particular population of animals such as accommodating smaller jaw size, higher risks of urinary stones, constipation and dental diseases.

Thus, there remains a need for treatment options for cutaneous adverse food reactions that have clinical efficacy, but are also specifically adapted to the needs of small dogs.

Thus, there remains a need for novel diets designed to improve both immune function and barrier defences that are specifically tailored to the needs of small dogs.

### SUMMARY

A first aspect of the present disclosure relates to a nutritionally complete food composition for a companion animal, wherein said companion animal is in particular a small dog, and wherein said composition includes:
from about 30 to about 85 g/Mcal of proteins, said proteins comprising at least 80% of hydrolyzed proteins by weight relative to the total dry matter weight of the proteins,
from about 3.5 to about 6 g/Mcal of soluble fibers,
from about 45 to about 200 g/Mcal of maize starch,
from about 0.1 to about 2.5 g/Mcal of omega-3 fatty acids,
from about 4 to about 12 g/Mcal of omega-6 fatty acids, and
about 0.26 g/Mcal or less of zeolite.

In a particular embodiment, said soluble fibers are selected from fructooligosaccharides (FOS).

In a particular embodiment, the food composition comprises about 0.026 g/Mcal or less, more particularly about 0.0026 g/Mcal or less, and still more particularly does not contain any zeolite.

In a particular embodiment, the food composition comprises from about 52 to about 65 g/Mcal of proteins, said proteins comprising at least 80% of hydrolyzed proteins by weight relative to the total dry matter weight of the proteins.

In particular, said proteins comprise at least 85% hydrolyzed proteins by weight relative to the total dry matter weight of the proteins.

In particular, the hydrolyzed proteins comprise feather hydrolysates, in particular poultry feather hydrolysates.

In a particular embodiment, the food composition comprises from about 26 to about 52 g/Mcal of fat. In particular, the fat is selected from vegetable fat, animal fat, or mixtures thereof. In a particular embodiment, the fat is vegetable fat which originates from soja, copra, coconut, wheat, sunflower, safflower, rapeseed, olive, borage, flaxseed, peanuts, blackcurrant seed, cottonseed, germ, corn germ, algae, or a combination thereof. In another particular embodiment, the fat is animal fat selected from fish oil, krill oil, poultry fat, pork fat, beef fat or a combination thereof.

In a particular embodiment, the food composition further comprises insoluble fibers, in particular insoluble fibers selected from purified cellulose, lignocellulose, soya, corn, wheat, pea, rice hulls, and combinations thereof.

In a particular embodiment, the omega-3 fatty acids include docosahexaenoic acid (DHA) and/or eicosapentaenoic acid (EPA).

In a particular embodiment, the omega-6 fatty acids include linoleic acid.

In a particular embodiment, the food composition further comprises one or more veterinary active ingredients in particular selected from dental health ingredients, such as calcium tripolyphosphate, or sodium hexametaphosphate and urinary safety ingredients, such as urine acidifiers, for example calcium sulphate, and combinations thereof.

In a particular embodiment, the food composition further comprises one or more additional ingredients selected from colorants, flavors, additives, conservatives such as antioxidants including lutein or beta carotene, vitamins such as choline, amino acids such as taurine, trace elements such as zinc, and minerals.

In a particular embodiment, the food composition is in the form of kibble. In particular, the kibble has a size which does not exceed about 12 mm×12 mm×6 mm, in particular about 10 mm×9 mm×5.5 mm, more particularly about 9 mm×8.5 mm×5 mm.

According to another aspect, the present disclosure relates to a method for manufacturing a nutritionally complete food composition as defined herein including at least one step of mixing the ingredients together.

According to another one of its aspects, the present disclosure relates to a method for preventing and/or treating cutaneous adverse food reaction in a small dog comprising at least a step of administering a nutritionally complete food composition as defined herein to said small dog.

In a particular embodiment, a small dog as defined herein is a dog which weighs 10 kg or less, and in particular, is an adult dog which weighs 10 kg or less.

### DETAILED DESCRIPTION

The objective of the present disclosure is to provide a product for preventing and/or treating cutaneous adverse food reaction, in particular in small dogs.

For clarity and not by way of limitation, the detailed description of the presently disclosed subject matter is divided into the following subsections:
1. Definitions;
2. Food compositions for a companion animal;
3. Method for preparing the food compositions; and
4. Therapeutic or non-therapeutic applications.

### 1. DEFINITIONS

The terms used in this specification generally have their ordinary meanings in the art, within the context of this disclosure and in the specific context where each term is used. Certain terms are discussed below, or elsewhere in the specification, to provide additional guidance in describing the compositions and methods of the disclosure and how to make and use them.

As used in the specification and the appended claims, the singular forms “a”, “an”, and “the” include plural referents unless the context clearly dictates otherwise. Thus, for example, reference to “a compound” includes mixtures of compounds.

The term “about” or “approximately”, as used herein, means within an acceptable error range for the particular value as determined by one of ordinary skill in the art, which will depend in part on how the value is measured or determined, i.e., the limitations of the measurement system. For example, “about” can mean within 3 or more than 3 standard deviations, per the practice in the art. Alternatively, “about” can mean a range of up to 10%, more preferably up to 5%, and more preferably still up to 1% of a given value.

Ranges provided herein are understood to be shorthand for all of the values within the range. For example, a range of 1 to 50 is understood to include any number, combination of numbers, or sub-range from the group consisting 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 as well as all intervening decimal values between the aforementioned integers such as, for example, 1.1, 1.2, 1.3, 1.4, 1.5, 1.6, 1.7, 1.8, and 1.9. Ranges disclosed herein, for example, “between about X and about Y” are, unless specified otherwise, inclusive of range limits about X and about Y as well as X and Y. With respect to sub-ranges, “nested sub-ranges” that extend from either endpoint of the range are specifically contemplated. For example, a nested sub-range of an exemplary range of 1 to 50 can include 1 to 10, 1 to 20, 1 to 30, and 1 to 40 in one direction, or 50 to 40, 50 to 30, 50 to 20, and 50 to 10 in the other direction.

As used herein, the terms “includes”, “including”, “comprises,” “comprising,” or any other variation thereof, are intended to cover a non-exclusive inclusion, such that a process, method, article, or apparatus that comprises a list of elements does not include only those elements but can include other elements not expressly listed or inherent to such process, method, article, or apparatus.

In the detailed description herein, references to “embodiment,” “an embodiment,” “one embodiment,” “in various embodiments,” etc., indicate that the embodiment(s) described can include a particular feature, structure, or characteristic, but every embodiment might not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

As used herein, the expression “adverse food reaction” is referring to an abnormal or exaggerated immune response of a companion animal to the ingestion of a food composition, which negative response can cause a reduced appetite that could lead to a refusal of the diet or a food aversion. An adverse food reaction response can be immune-mediated which is referred to as a food allergy. The said negative response can also be a non-immune-mediated response, called a food intolerance. Illustratively, an adverse food reaction encompasses pruritus, often referred as to itching, and can result in additional dermatological signs, such as alopecia, seborrhoea or pyoderma.

As used herein, the term “preventing”, can also include the reduction of a likelihood of occurrence, or of re-occurrence, of a given condition in an animal.

As used herein, “allergic inflammatory skin disease” is characterized by producing one or more of erythema, pain, redness, swelling and small vesicles or papules on the skin. Body regions that are frequently affected in atopic dermatitis include the head, pinnae, feet, ventral abdomen and axillae. As used herein, the term “allergic” refers to a deregulated or unregulated sensitivity, in particular a hypersensitivity, of the immune system to typically harmless substances, such as those which are present in the environment. Common allergy triggers include but are not limited to airborne allergens, such as pollen, animal dander, dust mites and mold; certain foods, such as peanuts, tree nuts, wheat, soy, fish, shellfish, eggs and milk; insect stings, such as but not limited to from a bee or wasp; medications, such as penicillin or penicillin-based antibiotics; latex or other substances which can cause allergic skin reactions; allergic inflammatory skin disease such as atopic dermatitis, flea allergic dermatitis, urticaria, angioedema, inhalant allergy, inhalant allergic dermatitis, food allergic dermatitis, contact dermatitis, miliary dermatitis, eosinophilic granuloma, head and neck pruritus and generalized pruritus. It will thus be understood herein that the term “allergic” can relate both to “auto-antigens” and to exogenous antigens. It is known by the skilled person in the art that allergic inflammatory skin disease, can be diagnosed by several ways. As a non-limitative example, the allergic inflammatory skin disease can be diagnosed by measuring 2 quantitative outcomes. As used herein “2 outcomes” refers particularly to CADESI-04 and PVAS (Pruritus).

As used herein, the term “CADESI-04” refers to “Canine Atopic Dermatitis Extent and Severity Index” (Olivry et al., 2014; International Committee on Allergic Diseases of Animals (ICADA)), one of the scoring systems developed to diagnose severity of canine atopic dermatitis. CADESI-04 can also be used alongside the Canine Atopic Dermatitis Lesion Index to assess degree of erythema, lichenification and excoration. CADESI-04 is a stand-alone scoring system to assess the likelihood that an animal has allergic inflammatory skin diseases, especially atopic dermatitis, canine atopic dermatitis and assess the severity of the condition.

Pruritus Visual Analogue Score (PVAS) is measured with the Hills' Pruritus Visual Analogue Score (Hill et al., 2007). PVAS is scored by the scorer using a zero to ten analog scale, with a score of zero representing no pruritus/chewing and a score of ten equating to incessant and intense pruritus/chewing.

As used herein, the term “inflammation” refers to a local response to cellular injury that is marked by capillary dilatation, leukocytic infiltration, redness, heat and pain.

As used herein, the terms “animal”, “companion animal”, or “pet” refers to domestic animals including, but not limited to, domestic dogs, domestic cats, horses, cows, ferrets, rabbits, pigs, rats, mice, gerbils, hamsters, goats, and the like. Domestic dogs and cats are particular non-limiting examples of pets.

As used herein, the term “small dog” encompasses dogs, in particular domestic dogs, who weigh 10 kg or less. As such, a small dog can be an adult dog of a “small” breed or a puppy, less than one year old, of any race. Examples or small races include, but are not limited to affenpinscher, Australian terrier, beagle, bohon fries, border terrier, boston terrier, brussels griffon, Cairn terrier, cardigan Welsh corgi, cavalier king Charles spaniel, Cesky terrier, Chinese crested, corgi, coton de Tulear, Dachsund, dandie Dinmont terrier, English toy spaniel, French bulldog, Havanese, Italian greyhound, Lakeland terrier, Lhaso apso, löwchen, miniature bull terrier, miniature Schnauzer, Norfolk terrier, Norwegian lundehund, Norwich terrier, parson Russell terrier, Pekingese, Portuguese podengo pequeno, pug, Pyrenean shepherd, rat terrier, russel terrier, schipperke, Scottish terrier, Sealyhal terrier, Shetland sheepdog, Shih tzu, silky terrier, Skye terrier, Swedish vallhund, Tibetan spaniel, west Highland white terrier, and Xoloitzcuintli.

As used herein, the term “food composition” or “diet” covers all of foodstuff, diet, food supplement or a material that can contain proteins, carbohydrates and/or crude fats, which is used in the body of an organism to sustain growth, repair and vital processes and to furnish energy. Foods can also contain supplementary substances or additives, for example, minerals and vitamins (See Merriam-Webster's Collegiate Dictionary, 10th Edition, 1993). Such food compositions can be nutritionally complete or not. In a particular embodiment, an animal food composition according to the present disclosure is a nutritionally complete food composition. Illustratively, a food composition as described herein can include, but it is not limited to protein, crude fat, ash, crude fiber, starch, calcium, phosphorus, sodium, chloride, potassium, magnesium, iron, water, copper, manganese, zinc, selenium, vitamin A, vitamin D3, vitamin B1, vitamin B2, vitamin B6, vitamin B12, vitamin B7, vitamin B9, cholin chloride, arachidonic acid, W3 fatty acid or W6 fatty acid.

As used herein, “nutritionally complete” or “nutritionally balanced” means that the composition provides the complete and balanced nutritional requirement to animals. In certain embodiments such animals are dogs. Therefore, a nutritionally adequate feed is a feed with which the said animal, e.g., the said dog, can be fed as the sole ration and is capable of sustaining life without additional food (except water). The food composition can contain a carrier, a diluent, or an excipient. Depending on the intended use, the carrier, diluent, or excipient can be chosen to be suitable for animal use. In certain embodiments, the animal is a canine. In certain particular embodiments, the animal is a dog. In a general manner, nutritionally complete compositions comprise at least one source of proteins (or polypeptides), such as protein extracts, at least one source of vitamins, minerals, trace elements and fats.

As used herein, a “food supplement” refers to a concentrated source of nutrients, such as but not limited to vitamins and minerals, substances for nutritional or physiological purposes, or plants and plant preparations intended to compensate for deficiencies in an animal's regular diet. In certain embodiments, a food supplement is marketed in the form of capsules, lozenges, tablets, pills, powder packets or liquid forms (ampoules, vials with droppers).

As used herein, the term “drug” refers to any substance or composition represented as having treatment, curative or prevention properties against animal diseases. By extension, a medicinal product includes any substance or composition that can be used or administered to animals for the purpose of making a medical diagnosis or restoring, correcting or modifying their physiological functions by exercising a pharmacological, immunological or metabolic action.

As used herein, the term “wet food” or “wet food composition” generally refers to a food composition that can have a moisture content of about 30% or more, generally of more than about 40% by weight, relative to the total weight of the food composition. In certain particular embodiments, the wet food composition can have a moisture content lower than about 90% in weight, relative to the total weight of the food composition. In general, it is the final product of a process including a final step of sterilization (instead of a drying step). In certain embodiments, the wet food consists of a chunk form, more particularly of chunks in gravy form. In certain particular embodiments, the wet food consists of chunks and gravy, chunks in jelly, loaf, mousse, terrine, bites form.

“Chunks and gravy” products include a preformed meat particle prepared by making a meat emulsion and by putting this meat emulsion through a muzzle under pressure and then cooked. A product, such as cooked meat, is diced into chunks, which are eventually mixed with a gravy or sauce. The two components are then filled into a container, usually a can or pouch, which is seamed or sealed and sterilized. As opposed to the ground loaf, chunk and gravy compositions have physically separated, discrete chunks (i.e., pieces of ground meat and grains) as prepared. These discrete particles are present in the gravy-type liquid in the final container. When serving, chunk and gravy products flow out of the can and can be easily mixed with other dry products. While the chunk and gravy products allow better integrity of the individual ingredients, the heterogeneous formulation of the chunk and gravy products are sometimes disfavored by consumers.

Wet food compositions are generally packaged in can-like containers and are considered “wet” in appearance because of the moisture contained therein. Two types of wet compositions are generally known in the art. The first is known in the art as “ground loaf.” Loaf products are typically prepared by contacting a mixture of components under heat to produce an essentially homogeneous, intracellular honeycomb-type mass or “ground loaf.” The ground loaf mass is then packaged into a cylindrical container, such as a can. Upon packing, ground loaf assumes the shape of the container such that the ground loaf must be cut when serving to a companion animal.

In certain embodiments, the wet food composition can be packaged. In this way, the consumer is able to identify, from the packaging, the ingredients in the food product and confirm that it is suitable for the particular pet in question. The packaging can be metal, plastic, paper or card.

As used herein, the term “dry food” or “dry food composition” generally refers to a food or composition having a moisture content of less than about 12% by weight, relative to the total weight of the food composition, and commonly even less than about 7% by weight, relative to the total weight of the food composition. In certain particular embodiments, dry food according to the present disclosure can have a moisture content of at most about 12% by weight. In certain embodiments, the said dry food can have a moisture content of about 7% or less, such as about 5% by weight. In certain particular embodiments, the dry food can have a moisture content of more than about 3% by weight, relative to the total weight of the food composition. For instance, the Examples provided herein illustrate a dry food having a moisture content of about 9.5% by weight, relative to the total weight of the food composition. In a certain particular embodiment, the dry food can be of a kibble. In certain embodiments, for example and without limitation, kibbles can include particulates; pellets; pieces of pet food, dehydrated meat, meat analog, vegetables, and combinations thereof; and pet snacks, such as meat or vegetable jerky, rawhide, and biscuits. The dry food composition can be manufactured by mixing together ingredients and kneading in order to make consistent dough that can be cooked. In general, it can be the final product of a process comprising an extrusion step followed by a drying step.

As used herein, the term “kibble” includes a particulate pellet like component of animal feeds, such as dog and cat feeds, typically having a moisture, or water, content of less than 12% by weight, relative to the total weight of the kibble. Kibbles can range in texture from hard to soft. Kibbles can range in internal structure from expanded to dense. Kibbles can be formed by an extrusion process. For instance, a kibble can be formed from a core and a coating to form a kibble that is coated, also called a coated kibble. It should be understood that when the term “kibble” is used, it can refer to an uncoated kibble or a coated kibble.

As used herein, the term “semi-moist food” or “semi-moist food composition” generally refers to a food composition with an intermediate moisture content of about 12% to about 30% in weight, relative to the total weight of the food composition. Hence, such semi-moist food composition is generally the final product of a process allowing a moisture content value that is intermediate between a dry food and a wet food. In certain embodiments, the said process can comprise a step of adding a humectant agent. In certain embodiments, the said process can comprise an extrusion step and a subsequent treatment step with Super-Heated Stream (SHS). In certain embodiments, the semi-moist food according to the present disclosure can contain more than about 12% and at most about 30% moisture by weight, relative to the total weight of the food composition. In certain embodiments, a semi-moist food composition can have about 11% to about 20% moisture by weight, relative to the total weight of the food composition, and/or a water activity of about 0.64 to about 0.75. In certain particular embodiments, a semi-moist food composition can have about 11% to about 20% moisture by weight, relative to the total weight of the food composition, and a water activity of about 0.64 to about 0.75.

As non-limitative example, semi-moist food can be obtained using Super-Heated Stream (SHS) processes such as processes or methods described in the published patent applications International Patent Publication No. WO2009/018990, International Patent Publication No. WO2009/018996, International Patent Publication No. WO2010/112097, International Patent Publication No. WO2014/122072, International Patent Publication No. WO2016/071372 and/or International Patent Publication No. WO2016/071367, the disclosures of which are incorporated herein in their entireties.

In a certain particular embodiment, when the animal food composition is a semi-moist food, it can be of soft semi-moist kibbles.

According to certain embodiments, the moisture content of an animal food composition can be determined by a Loss on Drying Method, comprising the steps of:
(a) Weighing a sample of a food composition, thereby obtained the total weight;
(b) Heating, such as 135±2° C. for 240 minutes, the sample of step a) in an oven until the moisture is all driven off, thereby obtained a dry sample;
(c) Weighing the dry sample; thereby obtained the dry weight;
(d) Calculating the difference between the total weight and the dry weight, thereby obtaining the moisture weight, as following:

$$Moisture weight = ( total weight ) - ( dry weight )$$

As used herein, the term “water activity” refers to the ratio of the partial vapor pressure of water in a food composition divided by the standard state partial vapor pressure of water. Several methods, known to the skilled person, can be employed to measure the water activity such as but not limited to a resistive electrolytic, a capacitance or a dew point hygrometer. In certain particular embodiments, it is referred to the method prescribed by the International Standard ISO 21087 relating to determining water activity in animal food and animal feeding stuffs.

As used herein, the terms “palatability” or “palatable” refer to being desirable to the palate or taste. Further, the terms “palatability” or “palatable” as used herein refer to the extent to which a pet food product appeals to the palate or taste of an animal. This is suitable measured by feeding tests, e.g., difference tests or ranking tests. In certain embodiments, “palatability” can mean a relative preference for one food product over another. For example, when an animal shows a preference for one of two or more food products, the preferred food product is more “palatable”, and has “enhanced palatability” or “increased palatability”. In certain embodiments, the relative palatability of one food product compared to one or more other food products can be determined, for example, in side-by-side, free-choice comparisons, e.g., by relative consumption of the food products, or other appropriate measures of preference indicative of palatability, i.e., “the two-bowl test”.

The term “carbohydrate” includes for example without limitation, cereals, grains, corn, wheat, rice, oats, corn grits, sorghum, grain sorghum (milo), wheat bran, oat bran, amaranth, durum, semolina, or mixtures thereof. As used herein, the term “protein source” can encompass “animal protein sources”, “plant protein sources”, or any other amino acid source, or combinations thereof. According to some embodiments, the protein source can include or can consist of hydrolyzed proteins, e.g., partially or totally hydrolyzed proteins. Methods to hydrolyze, partially or totally proteins are well-known. A hydrolysate can be produced by any known chemical or enzymatic method, such as, in non-limiting example, methods disclosed in U.S. Pat. Nos. 5,589,357, 4,879,131, 5,039,532 or EP 1 236 405 B1. Hydrolyzed proteins can also encompass a combination of amino acids.

As used herein, the term “animal protein” refers to animal-based sources of protein. Such animal protein can include, for example without limitation, meat (for example, pork, beef, or veal), poultry (for example, chicken), fish, organs (for example, liver, spleen, or heart), viscera (for example, viscera of chicken or pork), and combinations thereof. As animal proteins, one can select, in a non-exhaustive manner, animal proteins from poultry, beef, chicken, chicken meal, lamb, lamb meal, dried egg, fish, fish meal, meat and bone meal, meat byproducts, meat meal, turkey, blood plasma or bone marrow.

As plant or vegetal proteins, one can select, in a non-exhaustive manner, vegetal proteins from soybean, chickpea, pea, corn gluten, rice, insects, lentils, or barley.

As used herein, the term “amino acid” can refer to any naturally occurring or non-naturally occurring amino acid. In a non-exhaustive manner, the amino acid can be selected from the group consisting of: Alanine, Arginine, Asparagine, Aspartate, Cysteine, Glutamate, Glutamine, Glycine, Histidine, Isoleucine, Leucine, Lysine, Methionine, Phenylalanine, Proline, Serine, Taurine, Threonine, Tryptophan, Tyrosine, and Valine or a combination thereof. Essential amino acids are amino acids that cannot be made by the body and, as a result, must come from food. The essential amino acids for dogs are Arginine, Histidine, Isoleucine, Leucine, Lysine, Methionine, Phenylalanine, Threonine, Tryptophan and Valine.

As used herein, the term “amino acid source” means a material containing amino acids. Said amino acid source can include or be derived from, but is not limited to, plant proteins, animal proteins, proteins from single cell organisms and free amino acids.

As used herein, the term “fat” refers to the total amount of digestible, partially digestible and nondigestible fats or oils that are present in the embodiments of the present disclosure; especially the food products or compositions for which fat oxidation should be prevented or delayed. As used herein, the terms “lipid”, “fat” and “oil” are synonymous. Fat content of foods can be determined by any number of methods known by those of skill in the art.

As used herein, and unless specified otherwise, the term “oligosaccharide” refers to a compound containing two or more monosaccharide units linked by glycosidic bonds. Accordingly, it can refer to all types of oligosaccharides, such as those found from natural and synthetic sources, including those susceptible to be obtained through microorganisms.

Fibers are comprised in an animal food composition disclosed herein. The expression “fibers” is similar to “dietary fibers” and shall be interpreted for the purpose of the present disclosure as Total Fibers, meaning that it includes soluble fibers and insoluble fibers. Soluble fiber can be defined as being resistant to digestion and absorption in the small intestine and undergo complete or partial fermentation in the large intestine by opposition to insoluble fiber that can be defined as non-starch polysaccharides that are resistant to digestion and absorption in the small intestine, and resistant to fermentation in the large intestine. Soluble fibers are considered as having a prebiotic effect by providing short chain fatty acids as a source of energy to colonocytes. Insoluble fibers are considered as useful for transit and ballast effect. As non-limitative example of fibers, it can be mentioned a first group including beet pulp, guar gum, chicory root, psyllium, pectin, blueberry, cranberry, squash, apples, oats, beans, citrus, barley, or peas, and a second group comprising cellulose, whole wheat products, wheat oat, corn bran, flax seed, grapes, celery, green beans, cauliflower, potato skins, fruit skins, vegetable skins, peanut hulls, and soy fiber.

Soluble fibers of the disclosure include fructooligosaccharides (FOS), also sometimes called oligofructose or oligofructan, are oligosaccharide fructans. These compounds are short oligosaccharides with an average degree of polymerization (DP) of about 2, about 3, about 4, about 5, about 6, or about 7. FOS can be produced by degradation of inulin, or polyfructose, a polymer of D-fructose residues linked by β(2→1) bonds with a terminal α(1→2) linked D-glucose. Examples of FOS can include 1-kestose, nystose, 1F-β-fructofuranosyl nystose, or combinations thereof. For example, scFOS according to the present disclosure can include short-chain fructooligosaccharides (scFOS) obtained from sucrose; consisting of a combination of 1-kestose (GF2) (about 37%), nystose (GF3) (about 53%), and 1F-β-fructofuranosyl nystose (GF4) (about 10%). GF2, GF3, and GF4 are formed by a sucrose (glucose-fructose) molecule linked to respectively one, two or three fructose units added by β2-1 glycosidic linkages to the fructose unit of sucrose.

### Units

All weight percentages expressed herein are expressed:
by weight of the total weight of dry matter of the food composition, or
by weight per Mcal (megacalorie), unless expressed otherwise.

As used herein, an amount of a component as expressed as weight/kcal consists of a weight amount of the said component by unit of Metabolizable Energy (ME) of the total animal food composition.

As used herein, the ME parameter is intended to represent the energy value of a food composition that is directly metabolized after consumption. Within the scope of the present disclosure, the ME value can be measured by any suitable method known in the art.

Illustratively, the ME value can be measured using feeding trial. In practice, the gross energy (GE) of the food is determined in the laboratory, and the amounts of food eaten by the animals are recorded. The feces and urine from the animals are collected, and the energy in each is determined and called fecal energy (FE) and urinary energy (UE), respectively. The ME is then calculated as:

$$ME ( kcal / kg ) = [ G E - ( F E + U E ) ] / Kg of food consumed .$$

Alternatively, the ME value can be measured by a mathematical method, in particular taking into account the percentage of crude fat (CF), of crude protein (CP), and carbohydrates (NFE) in the composition. In practice each percentage is multiplied by its respective Atwater Factors. The resulting sum is then multiplied by 10. The mathematical method can be represented by the following formula:

$$ME ( kcal / kg ) = 10 \times [ ( 3.5 \times CP ) + ( 8.5 \times CF ) + ( 3.5 \times NFE ) ] .$$

### 2. FOOD COMPOSITIONS FOR A COMPANION ANIMAL

The present disclosure provides a nutritionally complete food composition for a companion animal. The food compositions of the present disclosure can include a wide variety of components. Non-limiting examples of components that can be incorporated in the food compositions of the present disclosure are listed below.

In certain embodiments, a nutritionally complete food composition for a companion animal according to the disclosure, wherein said companion animal is in particular a small dog, includes:
from about 30 to about 85 g/Mcal, particularly from about 35 to about 80 g/Mcal, and more particularly from about 39 to about 78 g/Mcal of proteins, said proteins comprising at least 80% of hydrolyzed proteins by weight relative to the total dry matter weight of the proteins,
from about 3.5 to about 6 g/Mcal, particularly from about 3.7 to about 5.5 g/Mcal, and more particularly from about 3.9 to about 5.2 g/Mcal of soluble fibers,
from about 45 to about 200 g/Mcal, particularly from about 50 to about 190, and more particularly from about 52 to about 185 g/Mcal of maize starch,
from about 0.1 to about 2.5 g/Mcal, particularly from about 0.25 to about 2.2 g/Mcal, and more particularly from about 0.5 to about 2 g/Mcal of omega-3 fatty acids,
from about 4 to about 12 g/Mcal, particularly from about 4.5 to about 10 g/Mcal, and more particularly from about 5 to about 9 g/Mcal of omega-6 fatty acids, and
about 0.26 g/Mcal or less, in particular about 0.026 g/Mcal or less, more particularly about 0.0026 g/Mcal of zeolite, and still more particularly does not contain any zeolite.

According to an embodiment of the disclosure, the soluble fibers can include fructooligosaccharides (FOS). In a particular embodiment, the soluble fibers include at least 50% of fructooligosaccharides (FOS), more particularly at least 60%, 70%, 80% or 90% of fructooligosaccharides (FOS) relative to the total weight of soluble fibers in the food composition. Still in another particular embodiment, the soluble fibers are fructooligosaccharides (FOS).

In a particular embodiment, a nutritionally complete food composition for a companion animal according to the disclosure, wherein said companion animal is in particular a small dog, includes: from about 30 to about 85 g/Mcal, particularly from about 35 to about 80 g/Mcal, and more particularly from about 39 to about 78 g/Mcal of proteins, said proteins comprising at least 80% of hydrolyzed proteins by weight relative to the total dry matter weight of the proteins, from about 3.5 to about 6 g/Mcal, particularly from about 3.7 to about 5.5 g/Mcal, and more particularly from about 3.9 to about 5.2 g/Mcal of soluble fibers selected from fructooligosaccharides (FOS), from about 45 to about 200 g/Mcal, particularly from about 50 to about 190, and more particularly from about 52 to about 185 g/Mcal of maize starch, from about 0.1 to about 2.5 g/Mcal, particularly from about 0.25 to about 2.2 g/Mcal, and more particularly from about 0.5 to about 2 g/Mcal of omega-3 fatty acids, from about 4 to about 12 g/Mcal, particularly from about 4.5 to about 10 g/Mcal, and more particularly from about 5 to about 9 g/Mcal of omega-6 fatty acids, and about 0.26 g/Mcal or less, in particular about 0.026 g/Mcal or less, more particularly about 0.0026 g/Mcal of zeolite, and still more particularly does not contain any zeolite.

### 2.1 Proteins

As discussed above, the nutritionally complete food composition of the disclosure can include from about 30 to about 85 g/Mcal, and particularly from about 35 to 80 g/Mcal, and more particularly from about 39 to about 78 g/Mcal of proteins, said proteins having at least about 80% of hydrolyzed proteins by weight relative to the total weight of proteins in the composition.

In a particular embodiment, a food composition of the disclosure can include from about 52 to about 65 g/Mcal of proteins, said proteins having at least about 80% of hydrolyzed proteins by weight relative to the total dry matter weight of the proteins.

In a particular embodiment, the proteins can have at least about 85% of hydrolyzed proteins, by weight relative to the total weight of dry matter of the composition. In a particular embodiment, the proteins can have at least about 90% of hydrolyzed proteins, by weight relative to the total weight of dry matter of the composition.

According to a particular embodiment, the nutritionally complete food composition of the disclosure can include from about 15% to about 30% of proteins, said proteins having at least about 80% of hydrolyzed proteins, by weight relative to the total weight of dry matter of the composition.

In certain embodiments, the protein level can be high enough so as to ensure maintenance of lean body mass of the animal. In certain embodiments, the food composition of the present disclosure can contain one or more distinct protein sources.

In a particular embodiment the food composition of the disclosure can include from about 20% to about 25% of proteins, said proteins having at least about 80% of hydrolyzed proteins, by weight relative to the total weight of dry matter of the composition.

In a particular embodiment, the hydrolyzed proteins can comprise feather hydrolysates, in particular poultry feather hydrolysates.

Surprisingly, it has been confirmed by the present disclosure that diets based on an extensively hydrolyzed feather protein can effectively manage small breed dogs known to have or highly suspected of cAFR.

In another embodiment, the hydrolyzed proteins can include amino acids. In a particular embodiment, the hydrolyzed proteins can be essentially amino acids. In a particular embodiment, the hydrolyzed proteins can be exclusively amino acids.

Said amino acids can be essential amino acids.

The amino acids can be naturally-occurring or synthetic.

The minimum amounts of amino acids which can be included in nutritionally complete animal food compositions, in particular in dog food compositions, can be for example provided in the AAFCO (USA) and in the FEDIAF (Europe) guidelines. These minimum amounts are presented in g/100 g of dry matter of the composition or in g/Mcal and are provided for the main amino acids in the table below:

TABLE 1
Amino acid content guidelines

| | AAFCO guidelines | | FEDIAF Guidelines | |
|---|---|---|---|---|
| | g of | g of | g of | g of |
| Amino acid | aa/Mcal | aa/100 g | aa/Mcal | aa/100 g |
| Arginine | 1.28 | 0.51 | 1.30 | 0.52 |
| Histidine | 0.48 | 0.19 | 0.58 | 0.23 |
| Isoleucine | 0.95 | 0.38 | 1.15 | 0.46 |
| Leucine | 1.70 | 0.68 | 2.05 | 0.82 |
| Lysine | 1.58 | 0.63 | 1.05 | 0.42 |
| Methionine + | 1.63 | 0.65 | 1.91 | 0.76 |
| Cysteine | | | | |
| Methionine | 0.83 | 0.33 | 1.00 | 0.40 |
| Phenylalanine | 1.13 | 0.45 | 1.35 | 0.54 |
| Phenylalanine + | 1.85 | 0.74 | 2.23 | 0.89 |
| Tyrosine | | | | |
| Threonine | 1.20 | 0.48 | 1.30 | 0.52 |
| Tryptophan | 0.40 | 0.16 | 0.43 | 0.17 |
| Valine | 1.23 | 0.49 | 1.48 | 0.59 |

All these amino acids can be found commercially. Examples of most common commercially available amino acids can include tryptophane, tyrosine and methionine.

### 2.2 Soluble Fibers Such as Fructooligosaccharides and Other Fibers

### 2.2.1 Soluble Fibers

The nutritionally complete food composition of the disclosure can include from about 3.5 to about 6 g/Mcal, particularly from about 3.7 to 5.5 g/Mcal, and more particularly from about 3.9 to about 5.2 g/Mcal of soluble fibers.

In particular, a food composition of the disclosure can include from about 4 to about 5 g/Mcal of soluble fibers.

In a particular embodiment, the nutritionally complete food composition of the disclosure can include from about 1% to about 2.5% of soluble fibers, by weight relative to the total weight of dry matter of the composition.

In certain embodiments, soluble fibers can be selected from fibers originating from chicory pulp, beet pulp, potato, guar gum, tomato pomace, and combinations thereof.

According to an embodiment of the disclosure, the soluble fibers include fructooligosaccharides (FOS). In a particular embodiment, the soluble fibers include at least 50% of fructooligosaccharides (FOS), more particularly at least 60%, 70%, 80% or 90% of fructooligosaccharides (FOS) relative to the total weight of soluble fibers in the food composition. Still in another particular embodiment, the soluble fibers are fructooligosaccharides (FOS).

The nutritionally complete food composition of the disclosure can include from about 3.5 to about 6 g/Mcal, particularly from about 3.7 to 5.5 g/Mcal, and more particularly from about 3.9 to about 5.2 g/Mcal of soluble fibers selected from fructooligosaccharides (FOS).

In particular, a food composition of the disclosure can include from about 4 to about 5 g/Mcal of soluble fibers selected from fructooligosaccharides (FOS).

In a particular embodiment, the nutritionally complete food composition of the disclosure can include from about 1% to about 2.5% of soluble fibers selected from fructooligosaccharides (FOS), by weight relative to the total weight of dry matter of the composition.

The FOS of the present disclosure can be obtained by a synthetic process method or by bacterial fermentation. When the FOS are obtained by bacterial fermentation, the FOS can be referred to as “fermented FOS”. Methods for obtaining FOS are known in the art.

### 2.2.2 Other Fibers

A food composition of the disclosure can include further soluble or insoluble fibers. The total fibers of the composition make up the “total amount of dietary fibers” or TDF. This includes the FOS, the additional soluble fibers and the insoluble fibers.

In certain embodiments, a food composition of the disclosure can include insoluble fibers. Insoluble fibers can be selected from purified cellulose, lignocellulose, soya, corn, wheat, pea, rice hulls, and combinations thereof.

In a particular embodiment, the composition can contain a TDF from about 2.6 to about 26 g/Mcal by weight, in particular from about 6.5 to about 21 g/Mcal by weight, more particularly from about 11.7 to about 14.3 g/Mcal by weight relative to the total dry matter weight of the composition.

According to an embodiment, the composition can contain a TDF from 1% to 10% by weight, in particular from 2.5% to 8% by weight, more particularly from 4.5% to 5.5% by weight relative to the total dry matter weight of the composition.

The TDF of a composition can be analyzed using the AOAC 991.43 method for “total, soluble and insoluble dietary fiber in foods” which includes enzymatic-gravimetric method and liquid chromatography.

### 2.3 Fats

A food composition of the disclosure can include from about 26 to about 52 g/Mcal of fat.

In a particular embodiment, a food composition of the disclosure can include from about 10% to about 20% of fat by weight relative to the total dry matter weight of the composition.

In a particular embodiment, the fat can be selected from vegetable fat, animal fat, or mixtures thereof.

In certain embodiments, the fat can be vegetable fat. As used herein, “vegetal fat” and “vegetable fat” are synonymous and interchangeable. The vegetable fat can originate from soja, coconut, wheat, sunflower, safflower, rapeseed, olive, borage, flaxseed, peanuts, blackcurrant seed, cottonseed, germ, corn germ, algae, or a combination thereof as well as oils derived from these. In a particular embodiment, the vegetal fat can be soya oil, copra oil or a combination thereof. In a more particularly embodiment, the vegetable fat can be soya oil.

In certain embodiments, the fat can be animal fat. The animal fat can originate from meat; meat by-products such as chicken fat, turkey fat, beef fat, duck fat, pork fat, lamb fat; fish oil, seafood; dairy; or eggs. In some embodiments, the animal fat can be selected from fish oil, krill oil, poultry fat, pork fat, beef fat or a combination thereof. In a particular embodiment, the animal fat can be selected from fish oil, krill oil, and/or a combination thereof. In a more particular embodiment, the animal fat can be fish oil.

In particular, the fats present in the composition can bring specific fatty acids that are important in the animal's nutrition.

A food composition of the disclosure can include from about 0.1 to about 2.5 g/Mcal, particularly from about 0.25 to about 2.2 g/Mcal, and more particularly from about 0.5 to about 2 g/Mcal of omega-3 fatty acids.

In a particular embodiment, a food composition of the disclosure can include from about 0.2% to about 0.8% of omega-3 fatty acids by weight relative to the total dry matter weight of the composition.

In a particular embodiment, the omega-3 fatty acids can include docosahexaenoic acid (DHA) and/or eicosapentaenoic acid (EPA).

As used herein, the term “EPA/DHA” designates a fatty acid or a mixture of fatty acids consisting of (i) only eicosapentaenoic acid (EPA), (ii) only docosahexaenoic acid (DHA) or (iii) a combination of eicosapentaenoic acid and docosahexaenoic acid (EPA+DHA).

Accordingly, an amount of “EPA/DHA” refers to EPA, or DHA or a combination of EPA and DHA.

In certain embodiments, the food composition as described herein, can include a combination of Eicosapentaenoic acid (EPA) and Docosahexaenoic acid (DHA) in a weight ratio of EPA:DHA of from more than 1, particularly from about 1 to about 100.

A food composition of the disclosure can include from about 4 to about 12 g/Mcal, particularly from about 4.5 to about 10 g/Mcal, and more particularly from about 5 to about 9 g/Mcal of omega-6 fatty acids.

In a particular embodiment, a food composition of the disclosure can include from about 2% to about 3.5% of omega-6 fatty acids by weight relative to the total dry matter weight of the composition.

In a particular embodiment, the omega-6 fatty acids can include linoleic acid.

As used herein, the term “linoleic acid” refers to a polyunsaturated omega-6 fatty acid, (9Z,12Z)-octadeca-9,12-dienoic acid, which is one of two essential fatty acids for animals.

For measuring the content of a food composition in linoleic acid, the one skilled in the art can refer to any of well-known techniques. For example, a method based upon the norm NF EN ISO 5508/5509 via chromatography in gaseous phase can be used.

In a particular embodiment, linoleic acid can be provided in the composition by vegetable oils. In a particular embodiment, linoleic acid can be provided in the composition by soya oil.

### 2.4 Further Ingredients

A food composition of the disclosure can include about 0.26 g/Mcal or less, in particular about 0.026 g/Mcal or less, and more particularly about 0.0026 g/Mcal of zeolite, and still more particularly does not contain any zeolite.

In a particular embodiment, a food composition of the disclosure can include about 0.1% or less of zeolite, in particular about 0.01% or less of zeolite by weight relative to the total dry matter weight of the composition, more particularly does not contain any zeolite.

Zeolites are microporous, aluminosilicate minerals commonly used as commercial adsorbents and catalysts. They are tetrahedral, three dimensional, crystalline minerals of aluminosilicate earth metals and belong to the acidic catalysts. These compounds can be included in animal food, in particular dog food, as additives, such as technological additives, or as binder or anti-caking agents.

According to other aspects of the present disclosure, the food composition can further include one or more additional ingredients which can be selected from colorants, flavors, additives, conservatives such as antioxidants including lutein or beta carotene, vitamins such as choline, amino acids such as taurine, trace elements such as zinc, and minerals.

### 2.4.1 Taurine

In certain embodiments, the food composition described herein can include taurine. Taurine is a non-essential amino acid which is obtained from meat and fish. It stimulates the production of glycosphingolipids in the skin by acting as a precursor molecule. Glycosphingolipids exhibit anti-microbial properties.

In certain embodiments, taurine according to the present disclosure refers to a compound of the following structure

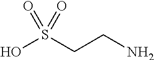

or one of its pharmaceutically acceptable salts and/or racemic, enantiomeric, diastereoisomeric or tautomeric forms.

### 2.4.2 Lutein

In certain embodiments, the food composition described herein can include lutein. As used herein, “lutein” refers to a xanthophyll and one of known naturally occurring carotenoids. Lutein is a lipophilic molecule and is generally insoluble in water. Lutein is synthesized only by plants and like other xanthophylls is found in high quantities in green leafy vegetables such as spinach, kale and yellow carrots. Lutein is isomeric with zeaxanthin, differing only in the placement of one double bond. The principal natural stereoisomer of lutein is (3R,3′R,6′R)-beta, epsilon-carotene-3,3′-diol. Lutein is present in plants as fatty-acid esters, with one or two fatty acids bound to the two hydroxyl-groups.

In certain embodiments, lutein according to the present disclosure refers to a compound of the following structure:

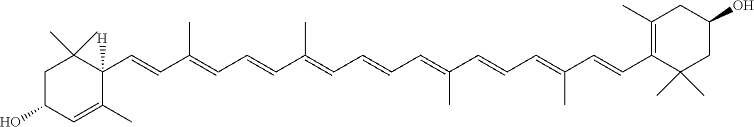 [SMILES: CC1=C[C@H](O)CC(C)(C)[C@H]1/C=C/C(C)=C/C=C/C(C)=C/C=C/C=C(C)/C=C/C=C(C)/C=C/C1=C(C)C[C@@H](O)CC1(C)C]

or one of its pharmaceutically acceptable salts and/or racemic, enantiomeric, diastereoisomeric or tautomeric forms.

### 2.4.3 Vitamin E

In certain embodiments, the food composition described herein can include vitamin E. Vitamin E is a collective term for several biologically similar compounds, including those called tocopherols and tocotrienols, which share the same biological activity. The most biologically active biological form of Vitamin E (also the most active antioxidant) in animal tissue is alpha-tocopherol. Vitamin E cannot be synthesized in vivo. Vitamin E protects against the loss of cell membrane integrity, which adversely alters cellular and organelle function. Vitamin E according to an aspect of the present disclosure can be in any form. It can be liquid, semi-solid or solid. It can be a tocopherol or a tocotrienol. It can be alphatocopherol, (d-x or dl-oc) beta-tocopherol (d-,B or dl-), gamma-tocopherol (dot or dim), delta-tocopherol, alpha-tocotrienol, beta-tocotrienol, gamma-tocotrienol or delta-tocotrienol. In certain particular embodiments, Vitamin E is alpha-tocopherol.

According to one embodiment, the source of the Vitamin E is not limiting. In certain embodiments, Vitamin E sources can include Vitamin E acetate, (e.g., tocopherol acetate), Vitamin E acetate adsorbate or Vitamin E acetate spray dried. In certain particular embodiments, sources of Vitamin E are synthetic, although natural sources can be used.

In certain embodiments, Vitamin E according to the present disclosure refers to a compound of the following structure:

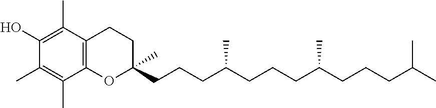 [SMILES: Cc1c(C)c2c(c(C)c1O)CC[C@@](C)(CCC[C@H](C)CCC[C@H](C)CCCC(C)C)O2]

or one of its pharmaceutically acceptable salts and/or racemic, enantiomeric, diastereoisomeric or tautomeric forms.

### 2.5 Supplementary Ingredients, Substances or Additives

In some embodiments, the food composition as described herein can be nutritionally complete and can also contain supplementary ingredients, substances or additives, for example NFE, ash, minerals, vitamins or condiments.

### 2.5.1 Nitrogen Free Extract (NFE)

In certain embodiments, the food composition described herein can include nitrogen free extract (NFE). As used herein, and as conventionally admitted in the art, the Nitrogen Free Extract (NFE) refers to the soluble carbohydrate fraction that can be optionally included in a food composition disclosed herein. NFE can encompass a wide variety of soluble polysaccharides, starch, gums, mucilages and pectin, if present in the food composition disclosed herein. As conventionally known in the art, NFE does not comprise the insoluble carbohydrate fraction comprised in the crude fiber material that can, in some embodiments, be present in the compositions of the present disclosure.

Typically, the content of a food composition in Nitrogen Free Extract is determined by subtracting the content of each of the other components (protein, crude fat, crude fiber, ash) from the whole dry matter of the said food composition.

In certain embodiments where the qualitative and quantitative features of a food composition is expressed as the energy density (e.g., the metabolizable energy density in g/Mcal), the NFE content is determined by subtracting the energy value of each of the other components (protein, crude fat, crude fiber, ash) from the energy value of the whole food composition.

In certain embodiments wherein the qualitative and quantitative features of a food composition is expressed as a weight percentage (e.g., a weight percentage based on the total weight of dry matter of the said composition), the NFE content is determined by subtracting the weight percentage of the other components (protein, crude fat, crude fiber, ash) from the total weight of the said food composition.

In certain embodiments, where the qualitative and quantitative features of a food composition are expressed as a weight percentage (e.g., a weight percentage based on the total weight of dry matter of the said composition), the NFE content is determined by subtracting the weight percentage of the other components (protein, fat, crude fiber, ash) from the total weight of the said food composition.

### 2.5.2 Carbohydrates

In certain embodiments, the food composition described herein can include carbohydrates. As used herein, the term “carbohydrates” designates a mixture of polysaccharides and sugars that are metabolized for energy when hydrolyzed in the body.

The carbohydrate content in the food composition can be determined by any number of methods known by those of skilled in the art. Carbohydrates can be supplied under the form of any of a variety of carbohydrate sources known by those skilled in the art, including starch (any kinds, corn, wheat, barley, etc.) beet pulp (which contain a bit of sugars) and psyllium.

### 2.5.3 Starches

In certain embodiments, a food composition of the disclosure can include from about 45 to about 200, particularly from about 50 to about 190 g/Mcal, and more particularly from about 52 to about 185 g/Mcal of maize starch.

According to an embodiment, the food composition of the disclosure can include from about 20% to about 70% of maize starch.

The term “starch” as used herein refers to a polysaccharide that is composed of amylose and amylopectin. Starch occurs in many plant tissues as granules, usually between 1 and 100 μm in diameter, depending upon the plant source. Chemically, starches are polysaccharides composed of α-D-glucopyranosyl units linked together with α-D(1-4) and/or α-D(1-6) linkages and are comprised of two molecular types: amylose, the straight chain polyglucan comprised of approximately 1000, α-D(1-4) linked glucoses; and amylopectin, the branched glucan, comprised of approximately 4000 glucose unite with branches occurring as α-D(1-6) linkages.

As used herein, starch encompasses the various crystalline structures of A-type, B-type and C-type starches, which contain different proportions of amylopectin. A-type starches are found mainly in cereals, while B-type starches are found mainly in tubers and amylose-rich starches. C-type starch consists of a mixture of both A and B forms and is found mainly in legumes.

In general, digestible starches are broken down (hydrolyzed) by the enzymes a-amylases, glucoamylase and sucrose-iso-maltase in the small intestine to yield free glucose that is then absorbed.

Starch comprised in a food composition of the disclosure can be from maize.

In certain embodiments, wherein the starting materials can include also modified starch or pre-gelatinized starch, the starch content can also be determined according to NF EN ISO 15914.

### 2.5.4 Ash

In certain embodiments, the food compositions disclosed herein can include ash. Ash can include minerals, such as calcium, phosphorus, sodium, chloride, potassium, magnesium, or combinations thereof. The ash content, if specified as a result of an analytical measure of a food composition described herein, is a measure of the total amount of minerals comprised therein. The mineral content is a measure of the amount of specific inorganic components comprised therein, which includes calcium (Ca), sodium (Na), potassium (K) and chlorine (Cl).

As it shall be readily understood, every embodiment of a food composition encompassed by the present disclosure can include a variety of ingredients, each included in the said composition at a given weight percentage, as compared to the total weight of dry matter of the animal food composition.

### 2.5.5 Veterinary Active Ingredients

In certain embodiments, the food composition disclosed herein can include one or mor veterinary active ingredients. By “veterinary active ingredients” it is understood ingredients that have a biological effect on the animal that will consume it.

Veterinary active ingredients of the disclosure can include dental health ingredients, such as calcium tripolyphosphate or sodium hexametaphosphate.

Veterinary active ingredients of the disclosure can also include urinary safety ingredients, such as urine acidifiers, for example calcium sulphate.

Veterinary active ingredients of the disclosure can also include skin barrier ingredients, such as urine linoleic acid or zinc, or a combination thereof.

In a particular embodiment, a food composition of the disclosure can be in the form of kibble.

When the composition is in the form of kibble, it can in particular include: from about 15% to about 30% of proteins, said proteins having at least about 80% of hydrolyzed proteins, from about 1% to about 2.5% of soluble fibers, in particular selected from fructooligosaccharides, from about 20% to about 70% of maize starch, from about 0.2% to about 0.8% of omega-3 fatty acids, from about 2% to about 3.5% of omega-6 fatty acids, and about 0.1% or less of zeolite, in particular about 0.01% or less of zeolite, more particularly does not contain any zeolite, by weight relative to the total dry matter weight of the composition.

According to an embodiment of the disclosure relating to kibble, the kibble size does not exceed about 12 mm×12 mm×6 mm, in particular 10 mm×9 mm×5.5 mm, and more particular about 9 mm×8.5 mm×5 mm.

In such a particular embodiment, the kibble can have a size which ranges from about 8 mm×7 mm×4.5 mm to about 15 mm×12 mm×8 mm, in particular from about 9 mm×8.5 mm×5 mm to about 12 mm×10 mm×6 mm. It must be understood that the shape and the size of the composition can be different and selected from the person skilled in that art in order to take account of specific parameters, such as without limitation the nature of the composition, the process used, the formulation, etc.

It should be noted that every embodiment of a nutritionally complete food composition encompassed by the present disclosure can include a variety of ingredients, each comprised in said food at a given weight percentage, as compared to the total weight of dry matter of the dry food composition.

Mainly, a nutritionally complete food composition as described herein can include protein, soluble fibers, maize starch, omega-3 and omega-6 fatty acids, and optionally one or more further ingredients such as vitamins, minerals, carbohydrates, NFE, ash, starch, preservatives etc., the sum of the weight of each of the ingredients comprised therein amounting to 100% by weight, based on the total weight of dry matter of the said dry food composition.

Illustratively, when the total amount of nutrient of the food composition as described herein, in particular protein, soluble fibers, maize starch, omega-3 and omega-6 fatty acids is of about 30% by weight, based on a dry matter basis, the amount of the other nutrients is of about 70% by weight to reach 100% of the total dry matter of the food composition.

### 3. METHOD FOR PREPARING FOOD COMPOSITIONS

In another aspect, the present disclosure also provides a method for manufacturing a nutritionally complete food composition specified herein. The process for the manufacture of the food composition as described can include any methods known in the art. The method can include at least one step of mixing the ingredients together. The composition can be a dry food, a wet food or a semi-moist food as described in the present disclosure. It can also be a food supplement.

In a particular embodiment relating to dry food, the food composition manufactured by the methods described herein, can be a kibble. The process of creating a dry food, e.g., kibble, is usually done by baking and/or extruding. The ingredients can be mixed in the proportions indicated in the table above, first the dry ingredients, then the wet ingredients. Water and steam are added in a preconditioner where it is made into a dough and start cooking. Then, the dough is typically fed into a machine called an expander and/or extruder, which uses pressurized steam or hot water to cook the ingredients. While inside the extruder, the dough is under extreme pressure and high temperatures. The dough is then pushed through a die (specifically sized and shaped hole) and then cut off using a knife, e.g., a rotary cutter. The puffed dough pieces are made into a dry product, such as a kibble, by passing it through a dryer so that moisture is dropped down to a defined target ensuring stability of the food until consumption. The obtained kibble, as non-limitative example, can have a size of about 9×8.5×5 mm. The kibble is entered into a revolving drum where it is coated with a mix of flavors and preservatives, before being cooled

In certain embodiments, the dry product, such as a kibble, can be sprayed with fats, oils, minerals, vitamins, the natural extracts cocktail and optionally sealed into packages. In certain particular embodiments, the dry food composition is packaged. In this way, the consumer is able to identify, from the packaging, the ingredients in the food product and confirm that it is suitable for the particular pet, e.g., dog, in question. The packaging can be metal, plastic, paper, or card.

### 4. THERAPEUTIC OR NON-THERAPEUTIC APPLICATIONS

In certain embodiments, the present provides the use of a nutritionally complete food composition as described herein for preventing and/or treating cutaneous adverse food reaction in small dogs. In certain embodiments, the present disclosure provides therapeutic and non-therapeutic applications of the nutritionally complete food composition as described herein.

In another aspect, the present disclosure provides the use of a nutritionally complete food composition as described herein for ensuring a good digestive tolerance. By “ensuring a good digestive tolerance”, it is meant that at least one of the following criteria is improved: absence of vomiting, absence of regurgitation, maintenance of body weight and condition and good hydration status.

In another aspect, the present disclosure provides the use of a nutritionally complete food composition as described herein for treating, or at least decreasing, vomiting.

In another aspect, the present disclosure provides the use of a nutritionally complete food composition as described herein for treating, or at least decreasing, regurgitation.

In another aspect, the present disclosure provides the use of a nutritionally complete food composition as described herein for maintaining the body weight and condition.

In another aspect, the present disclosure provides the use of a nutritionally complete food composition as described herein for maintaining a good hydration status.

In another aspect, the present disclosure provides the use of a nutritionally complete food composition as described herein for ensuring stool quality in a small dog suffering from cutaneous adverse food reaction.

By “ensuring stool quality”, it is meant that the faeces of an animal that is fed with a food composition if the invention is neither unacceptably soft nor unacceptably hard. The stool quality of an animal is considered to constitute a good marker of of its digestive tolerance. The more the stool is close to optimal consistency, colour and/or quantity the better the food composition is tolerated, on a digestive point of view, by the animal. The disclosure further provides a method for improving ensuring stool quality in a small dog further suffering from cutaneous adverse food reaction including at least a step of administering a nutritionally complete food composition as defined herein to said small dog.

In certain embodiments, the present disclosure further provides a method for preventing and/or treating allergic inflammatory skin diseases in a small dog including at least a step of administering a nutritionally complete food composition as defined herein to said small dog. In particular, allergic inflammatory skin diseases can include cutaneous adverse food reaction. It is further provided a method for preventing and/or treating cutaneous adverse food reactions in a small dog including at least a step of administering a nutritionally complete food composition as defined herein to said small dog.

Allergic inflammatory skin diseases can be selected from environmental allergies (such as allergies to pollens, dust, mites, etc), atopic dermatitis, flea allergic dermatitis, urticaria, angioedema, inhalant allergy, inhalant allergic dermatitis, food allergic dermatitis, contact dermatitis, miliary dermatitis, eosinophilic granuloma, head and neck pruritus and generalized pruritus. In certain particular embodiments, allergic inflammatory skin diseases can be atopic dermatitis, including atopic dermatitis in canine animals, especially in dogs.

As such, a food composition of the disclosure can be used for decreasing pruritus flares. In certain other embodiments, it can be used for decreasing the CADESI-04 score.

In certain other embodiments, the animal food composition can be used for reducing the dose and frequency of drugs required to manage the condition of an allergic inflammatory skin disease.

Beneficial effects can be obtained (i) in animals fed exclusively with the food composition described herein, (ii) in animals fed partly with the composition food described herein and another food composition, as well as (iii) in animals fed with the said food composition a supplement food or a drug. In a particular embodiment, beneficial effects can be obtained in animals fed exclusively with the food composition described herein.

In certain embodiments, (ii) “partly” means that the said food composition represents at least about 30% of the animal meal, at least about 50% of said animal meal, or even at least about 70% of said animal meal, or even at least about 80% of said animal meal, or even at least about 90% of said animal meal.

In certain embodiments, the food composition described herein can be provided to animals, especially to dogs, in particular small dogs, on a daily basis.

In certain embodiments, a food composition as disclosed herein can be provided to the animal to be treated as the sole nutritionally complete food during the time period of treatment. According to these embodiments, the said nutritionally complete animal food composition can be provided to the animal on a daily basis during the time period of treatment.

In certain other embodiments, a food composition as described herein can be provided to the animal to be treated in alternation with another animal food composition, with the proviso that said other animal food composition has been designed to avoid allergies, according to the general knowledge of the person skilled in the art. As non-limitative example, such other animal food composition, can include, as source of protein only amino acids or highly hydrolyzed proteins, and/or can include a low level of carbohydrates.

It shall be understood that, in the daily practice of feeding animals, especially dogs, the animal owner cannot proceed according to a systemic way of feeding the animal with an animal food composition always on daily basis. In certain embodiments, the beneficial effects of a food composition are fully provided when the animal is fed with the animal food composition herein once every few days. In particular embodiments, feeding the animal every three, four, five, six or seven days will cause a reduced beneficial effect, which can require a longer time period of treatment.

Without wishing to be bound by any particular theory, it is hypothesized that an efficient prevention or treatment of cutaneous adverse food reaction, such as a fully efficient prevention or treatment of allergic inflammatory skin diseases requires that the animal, especially the dog, can be provided with a food composition as described herein at least, if the food composition is provided to the animal once every few days, such as e.g., every other, every three, every four, every five, every six or every seven days. In certain particular embodiments, the food composition is provided to the animal on a daily basis.

The time period of feeding with a food composition as described herein can range from several weeks to several years, depending notably on the diagnosis and prognosis of the cutaneous adverse food reaction, which can include as an example the severity of the cutaneous adverse food reaction.

In certain embodiments, a short time period, e.g., 1 month, of treatment can be sufficient to decrease pruritus.

In certain other embodiments, the food composition can be provided to the animals to be treated for a longer period of time, such as for about 9 months or more, or about 12 months or more, either (i) according to a feeding schedule including providing to the animal, especially a dog, exclusively the food composition described herein or (ii) according to a schedule alternating the food composition described herein and another animal food composition.

### EXAMPLES

The presently disclosed subject matter will be better understood by reference to the following Examples, which are provided as exemplary of the disclosure, and not by way of limitation. The materials and methods used in the Examples are summarized below.

It has been shown in the following examples that the disclosed food composition is capable of acting on the progression of pruritus, erythema, pain, redness, swelling, small vesicles or papules in the animal. The efficiency of this composition has been established based on several criteria such as the quantitative criteria CADESI-04 and PVAS. Further, the present food composition allows good digestive tolerance by small dogs, as demonstrated by their fecal scores and also by the absence of vomiting or diarrhea.

### Example 1: Preparation of a Dry Food Composition in the Form of Kibble

A composition according to the disclosure was prepared according to the method described here below.

The composition had the following formula as shown in Table 2:

TABLE 2
Composition of the prepared dry food composition

| | % weight relative to |
|---|---|
| | the total weight of |
| Ingredient | the composition |
| Hydrolyzed proteins from poultry feathers | 15-30% |
| Fructooligosaccharides (FOS) | 1.5-2% |
| Purified maize starch | 20-70% |
| Omega 3 fatty acids | 0.2-0.8% |
| Omega 6 fatty acids | 2-3.5% |
| Other classic ingredients (fats, preservatives, | s.p. 100% |
| minerals, trace elements, amino acids, | |
| emulsifiers, fibers, flavours, colouring, etc.) | |

The composition does not contain any zeolite.

The ingredients were mixed in the proportions indicated in the table above, first the dry ingredients, then the wet ingredients. Water and steam were added in a preconditioner where it was made into a dough and started cooking. The dough obtained entered an extruder, where it was cooked under pressure. The dough was then extruded out in “ribbons” of a predefined shape and sliced into a pre-specified size using a rotary cutter. The obtained kibble had a size of about 10×9×5.5 mm. The kibble was air dried in a dryer to remove the moisture, and cooled. It was then further cooked in a dryer before entering a revolving drum where it was coated with a mix of flavours and preservatives.

Throughout the manufacturing process, the NPPI methodology (Lesponne et al., Vet. Sci, 2018, 5(3), 63) was used to guarantee no cross-contamination of the food (via purity of ingredients, cleaning of factory lines, and control via DNA analyses on finished product).

### Example 2: Efficacy of a Dry Food Composition of the Disclosure Against AFR in Small Dogs

### Materials and Methods

The study was an uncontrolled, multi-centre, field trial which included four French veterinary practices. Client-owned adult dogs meeting the inclusion criteria were recruited: small dogs (body weight (BW)≤10 kg), diagnosed with cutaneous adverse food reaction (cAFR) or strongly suspected. All dogs had been stabilized with a commercially available extensively hydrolyzed feather protein-diet (Anallergenic® canine dry diet, Royal Canin, France) for at least 2 months prior to enrolment. Dogs were considered stabilized if CADESI-04 was ≤10 (Canine Atopic Dermatitis Extent and Severity Index-4) and pruritus score was ≤1 (PVAS; 5-point scale: 0: absence of pruritus to 5: severe and frequent pruritus). Dogs had to be assessed as healthy based on physical examination, aside from dermatological disorders, and results of CBC, serum chemistry and urinalysis to be within normal ranges. They should not have received long-acting anti-pruritic medication.

Pregnant or lactating females were not included. Dogs with dental disease affecting kibble prehension were not included and changes or interruption in usual treatments (before or during the study) triggered non-inclusion or removal.

The kibble used in this study diet had the composition provided in Example 1.

This diet differed from the composition of Anallergenic® in particular in that it contained a higher amount of FOS and in that it did not contain any zeolite.

Following a recommended four day transition period (D1=75% old food/25% study diet, D2=50% old food/50% study diet, D3=25% old food/75% study diet and D4=100% study diet) (longer duration if gastrointestinal sensitivity), all dogs were fed the diet according to the invention exclusively for four weeks, as per the feeding guide which was provided. Animals had to be fed as usually according to the quantities they were used to receiving before the inclusion in the study. Only treats known to be tolerated by the dogs were allowed during the study. Access to other food sources including human food and other pet food was not allowed. Owners were instructed on food storage to minimize cross-contamination risks.

There was a total of three visits, inclusion visit 1 (V1), and V2 and V3, 2 and 4 weeks after inclusion respectively. A phone call on day 10 was made by the recruitment agency to evaluate food tolerance and acceptance. Dogs were clinically assessed by a veterinarian skilled in dermatology at the three visits. Assessments comprised full clinical examination, scoring of skin lesions (CADESI-04) and pruritus along with recording of body weight (BW) and body condition score. Owners made daily assessments of their dog's feeding behaviour and their dog's digestive tolerance was determined using a faecal score chart.

The CADESI-4 (Canine Atopic Dermatitis Extent and Severity Index) and PVAS (Pruritus Visual Analog scale) scores at V3 were compared to V1 through a difference test (linear mixed model with time as fixed effect and animal as random effect), then an equivalence test (paired Two-One-Sided-t-test).

The CADESI-4 is a simplified severity scale for assessing skin lesions of atopic dermatitis in dogs. For each body region, the degree of erythema, lichenification and excoriation is rated from 0 to 3. (0=none; 1=mild; 2=moderate, 3=severe). The PVAS consists of a 11-point linear scale with increasing numbers corresponding to higher severity of pruritic manifestations.

Both these scales are well known and validated in the art and used by many veterinarians, in particular for dermatology purposes in clinical trials.

### Results

Ten dogs were included and all dogs completed the study (8 females including 6 neutered, and 2 intact males, from 5 different breeds and 2 cross-breed dogs, aged 5.3 yrs±2.6, mean BW at inclusion 7.2 kg±2.4). No adverse events were reported, and no animals were withdrawn.

TABLE 3
CADESI-04 score-evolution throughout the study

| Visit | N | mean ± sd | median | min | max |
|---|---|---|---|---|---|
| V1 | 10 | 4.1 ± 2.9 | 4.0 | 0 | 10 |
| V2 | 10 | 3.7 ± 2.5 | 4.0 | 1 | 8 |
| V3 | 10 | 3.1 ± 3.2 | 2.5 | 0 | 9 |

The mean CADESI-04 scores showed no significant difference over the test phase (V1 to V3); and the equivalence test was significant (p<0.001).

TABLE 4
Pruritus score evolution throughout the study

| Visit | N | mean ± sd | median | min | max |
|---|---|---|---|---|---|
| V1 | 10 | 0.8 ± 0.4 | 1.0 | 0 | 1 |
| V2 | 10 | 0.7 ± 0.5 | 1.0 | 0 | 1 |
| V3 | 10 | 0.6 ± 0.5 | 1.0 | 0 | 1 |

The pruritus score analyses showed no significant differences over the test phase and a significant equivalence (p<0.001).

In conclusion, the dogs were successfully switched over to the test food with no significant changes in skin lesions or pruritus scores. The results presented confirmed that the test diet designed for small dogs had a similar efficacy on skin condition as the previous diet.

### Example 3: Digestibility of a Dry Food Composition of the Disclosure in Small Dogs

Three compositions have been designed for the present example:
(1) Anallergenic®, a commercial product sold by Royal Canin, discussed above (FORMULA 1),
(2) a comparative formula comprising less than 1.5% by weight of FOS relative to the total weight of the composition (FORMULA 2), and
(3) a food composition according to the invention (formula provided in Example 1) (FORMULA 3).

The study length required 10 days and pets were fed with the same diet during the 10 days (5 days of acclimatation of the diet and 5 days of fecal collection). No less than 6 animals had to complete the study. All animals included in the study were stool graded daily during the fecal collection phase thanks to the fecal score scale hereinafter.
Score 1: Entirely liquid stool
Score 1.5: Liquid stool with minimal consistency
Score 2: Very wet, but not liquid stool
Score 2.5: A moist stool with little consistency and no real shape
Score 3: A moist stool with no cracks
Score 3.5: A moist stool that's starting to take its shape and cracks
Score 4: A stool that has clearly defined shape with visible cracks
Score 4.5: A stool that has very clearly defined cracks
Score 5: Hard, dry, crumbly stool

According to the consistency of their faeces, the faeces were separated into 5 categories: very soft, soft, optimal, very hard and hard.

The results are provided in the table below (the percentage corresponds to the number of dogs present in each category, compared to the total number of dogs):

TABLE 5
Results of faecal test for the three formulas

| | SOFT | | | HARD | |
|---|---|---|---|---|---|
| | very soft | soft | OPTIMAL | hard | very hard |
| FORMULA 1 | 0% | 1% | 10% | 35% | 52% |
| FORMULA 2 | 3% | 2% | 7% | 32% | 57% |
| FORMULA 3 | 3% | 1% | 23% | 61% | 11% |

As can be seen above, the dogs fed with Formulas 1 and 2, outside of the invention, presented a high proportion of very hard faeces.

On the contrary, dogs fed with Formula 3 (i.e., a food composition of the disclosure) comprised a much lower proportion of dogs having very hard faeces. In fact, most of the dogs fed with a composition of the disclosure presented acceptable or even optimal consistency of faeces. This is representative of a good digestibility of the composition for the targeted small dog population.

Although the presently disclosed subject matter and its advantages have been described in detail, it should be understood that various changes, substitutions and alterations can be made herein without departing from the spirit and scope of the application as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the presently disclosed subject matter, processes, machines, manufacture, compositions of matter, means, methods, or steps, presently existing or later to be developed that perform substantially the same function or achieve substantially the same result as the corresponding embodiments described herein can be utilized according to the presently disclosed subject matter. Accordingly, the appended claims are intended to include within their scope such processes, machines, manufacture, compositions of matter, means, methods, or steps.

For any patents, patent applications, publications, product descriptions, and protocols are cited throughout this application, the disclosures of all of which are incorporated herein by reference in their entireties for all purposes.

1. A nutritionally complete food composition for a companion animal, wherein said companion animal is in particular a small dog, and wherein said composition includes:
from about 30 to about 85 g/Mcal of proteins, said proteins comprising at least 80% of hydrolyzed proteins by weight relative to the total dry matter weight of the proteins,
from about 3.5 to about 6 g/Mcal of soluble fibers,
from about 45 to about 200 g/Mcal of maize starch,
from about 0.1 to about 2.5 g/Mcal of omega-3 fatty acids,
from about 4 to about 12 g/Mcal of omega-6 fatty acids, and
about 0.26 g/Mcal or less of zeolite.

2. The food composition according to claim 1, wherein said soluble fibers are selected from fructooligosaccharides (FOS).

3. The food composition according to claim 1, comprising about 0.026 g/Mcal or less of zeolite, more particularly about 0.0026 g/Mcal or less of zeolite.

4. The food composition according to claim 1, comprising from about 52 to about 65 g/Mcal of proteins, said proteins comprising at least 80% of hydrolyzed proteins by weight relative to the total dry matter weight of the proteins.

5. The food composition according to claim 1, wherein said proteins comprise at least 85% hydrolyzed proteins by weight relative to the total dry matter weight of the proteins.

6. The food composition according to claim 1, wherein the hydrolyzed proteins comprise feather hydrolysates, in particular poultry feather hydrolysates.

7. The food composition according to claim 1, further comprising from about 26 to about 52 g/Mcal of fat.

8. The food composition according to claim 7, wherein the fat is selected from vegetable fat, animal fat, or mixtures thereof.

9. The food composition according to claim 8, wherein the fat is vegetable fat which originates from soja, copra, coconut, wheat, sunflower, safflower, rapeseed, olive, borage, flaxseed, peanuts, blackcurrant seed, cottonseed, germ, corn germ, algae, or a combination thereof.

10. The food composition according to claim 8, wherein the fat is animal fat selected from fish oil, krill oil, poultry fat, pork fat, beef fat or a combination thereof.

11. The food composition according to claim 1, further comprising insoluble fibers, selected from purified cellulose, lignocellulose, soya, corn, wheat, pea, rice hulls, and combinations thereof.

12. The food composition according to claim 1, wherein the omega-3 fatty acids include docosahexaenoic acid (DHA) and/or eicosapentaenoic acid (EPA).

13. The food composition according to claim 1, wherein the omega-6 fatty acids include linoleic acid.

14. The food composition according to claim 1, further comprising one or more veterinary active ingredients selected from dental health ingredients, urinary safety ingredients, and combinations thereof.

15. The food composition according to claim 1, further comprising one or more additional ingredients selected from colorants, flavors, additives, conservatives, vitamins, amino acids, trace elements, and minerals.

16. The food composition according to claim 1, wherein the food composition is in the form of kibble.

17. The food composition according to claim 16 wherein the kibble has a size which does not exceed about 12 mm×12 mm×6 mm.

18. A method for manufacturing the nutritionally complete food composition of claim 1 including at least one step of mixing the ingredients together.

19. A method for preventing and/or treating cutaneous adverse food reaction in a small dog comprising at least a step of administering the nutritionally complete food composition of claim 1 to said small dog.

20. A food composition according to claim 19, wherein the small dog is a dog which weighs 10 kg or less, in particular is an adult dog which weighs 10 kg or less.
